(19) United States
(12) Patent Application Publication
(10) Pub. No.: US 2006/0178117 A1
(43) Pub. Date: Aug. 10, 2006

(54) Devices for protection against overheated operating temperatures of mobile telephones

(75) Inventor: Rainer K. Liedtke, Gruenwald (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Haeusermann Deutschland GmbH, Frankfurt (DE)

(21) Appl. No.: 11/291,848

(22) Filed: Dec. 2, 2005

(30) Foreign Application Priority Data
Dec. 3, 2004 (DE) 10 2004 058 435.4

(51) Int. Cl. H04B 1/38; H01Q 11/12

(52) U.S. Cl. 455/90.3; 455/117

(57) ABSTRACT

The invention relates to devices with which users of mobile telephones can receive early warnings and be able to react to malfunctions of the operating temperature due to overheating. Hereby the danger of injury to health or damage to property due to overheating of the batteries of mobile telephones can be prevented.

The invention relates to devices for protection against overheated operating temperatures of mobile telephones, especially in order to improve the physical degree of safety of the user.

It is known that mobile telephones need batteries or accumulators to store electrical energy to keep them in call-ready status, and that these are therefore implemented directly in mobile telephones. It is also known that these batteries are being designed with progressively small dimensions, in order to fit into the mobile telephones, whose dimensions are also becoming progressively smaller. To ensure that the usability period nevertheless remains relatively long, however, high energy densities are needed therefor. In many cases, however, this elevated energy density causes the danger of overheating of the batteries if adequate ventilation thereof is not assured. This situation is analogously comparable with the elevated operating temperature that can develop, for example, in the internal combustion engine of an overloaded motor vehicle that is not adequately cooled. For example, the occurrence of battery temperatures of up to 600° C. has already been detected in tests with mobile telephones. This aspect represents a considerable safety risk for mobile telephone users, however, since overheated mobile telephones can catch fire or even explode. Users have already been injured on many occasions due to incidents in which mobile telephones have overheated or even exploded. In particular, not only have body burns requiring medical treatment occurred, but also property damage has been suffered.

As a consequence of this permanently inherent danger that the energy supply of mobile telephones causes for the users thereof, there are required protective measures that detect the danger of battery overheating and allow countermeasures to be taken, in order to minimize or completely prevent the potential hazards thereof. The mobile telephones currently in use are not provided with suitable warning and protective devices of this type.

The object of the invention is to improve the protection against overheated operating temperatures of mobile telephones.

This object is achieved by the fact that the temperature status of the batteries is permanently and directly controlled during operation via a specific device, which has the form of a multi-component system composed of a microprocessor functioning as the controller and a heat sensor mounted directly on or in the vicinity of the battery, the microcontroller being connected to actuators or to the display of the mobile telephone in such a way that warning signals or warning information that can be perceived by the user's senses are transmitted via these means at a predetermined temperature limit, while actuators having a cooling function can also be activated at a particular temperature and operation of the mobile telephone is completely deactivated at a further temperature limit.

In a further embodiment of the invention, in order to improve the practical use, the warning signals are transmitted optically, acoustically, mechanically by vibration, chemically or by a combination of the foregoing.

In a further embodiment of the invention, in order to improve the practical use, the information about the current battery temperature is continuously displayed in digital or analog form on the display of the mobile telephone, or this information can be viewed on the display upon request by the user.

In a further embodiment of the invention, in order to improve the practical use, control of the operating temperature of the battery and of the actuators takes place via a default program in the microprocessor.

In a further embodiment of the invention, in order to improve the practical use, the entire temperature-control system is configured as a mechanically separate functional unit containing the battery and having the form of a card, which can be reversibly inserted into the mobile telephone.

In a further embodiment of the invention, in order to improve the practical use, control of the battery temperature takes place via a sensor that contactlessly measures the heat emission thereof by infrared means.

In a further embodiment of the invention, in order to improve the practical use, takes place via a sensor, which is composed of a flexible, electrically conductive film and is mounted directly on the surface of the battery.

In a further embodiment of the invention, in order to improve the practical use, mechanical elements that become deformed under the effect of heat, thermocouples or thermistors or combinations thereof are optionally used as further circuit elements.

In a further embodiment of the invention, in order to improve the practical use, the battery is ejected at a particular temperature by a mechanical device installed in the mobile telephone.

In a further embodiment of the invention, in order to improve the practical use, an active cooling device that is activated at a certain temperature limit is coupled with the temperature-control system.

In a further embodiment of the invention, in order to expand the practical use, capabilities for recording, storage, processing and transfer of data are integrated into the temperature-control system, data transmission being possible via electric lines, radio waves or optical beams.

In a further embodiment of the invention, in order to expand the practical use, the application of the temperature-control system is also provided for mobile battery-powered electrical devices whose batteries represent hazard potentials technically comparable to those of mobile telephones during handling.

The advantages of the invention lie in the fact that direct thermal control devices for batteries of mobile telephones do not yet exist as protective devices. To the contrary, because of the incidents that have occurred heretofore in this connection, it is only now that new safety standards in this regard are being evaluated.

The direct advantages of the invention follow from the fact that permanent monitoring and control of the operating temperature of the energy system is made possible therewith for the user of the mobile telephone. In this way, therefore, undesired hazards can be reduced.

Creation of an advance warning via direct control of the temperature at the location of the heat-generating battery itself is also necessary for early detection of a malfunction, since the external parts of mobile telephones are still at much lower temperature than is the battery located in the interior of the mobile telephone. Thus the user cannot perceive this by his or her own senses. The approach is therefore somewhat comparable with the cooling-water gauge of a motor vehicle, which displays a suitable operating temperature of the engine. This warning information also gives the user himself or herself the chance to deactivate the mobile telephone in good time or even to replace the battery and therefore to forestall damage thereto as well as other harmful effects on the mobile telephone. The automatic deactivation of the mobile telephone achieved by the microprocessor is a further protective measure if the hazard potential were to increase further and the advance warning were to be missed or disregarded by the user.

In addition, the control system can be used for all forms of such battery technologies designed for mobile service, especially for those provided with particularly high capacity, such as the lithium-polymer technologies that are now leading this field. A further technical benefit is that the systems can be manufactured economically and reproducibly in relatively large quantities with standard production means and can permit variable dimensions down to the micrometer scale.

A technical example of the invention, not to be construed as limitative, will be explained hereinafter:

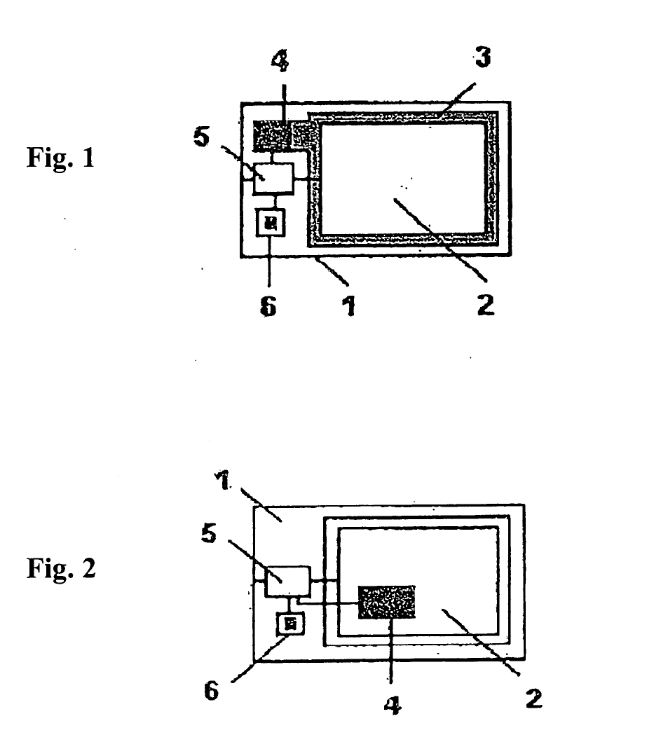

FIG. 1 shows a schematic view from above of one embodiment, which is not to be construed as limitative. Thus its purpose is merely further illustration of the fundamental principle. In this case, the battery together with the control system is located on a separate housing circuit board in card form (1), wherein battery (2) is disposed in a mechanical recess surrounded by an air-filled gap (3). Above this air space surrounding the battery, an infrared heat sensor (4) is in contactless measuring communication with the battery. The heat sensor is electrically connected to microprocessor (5), which in turn is electrically connected to battery (2) and to the further operating system of the mobile telephone, such as its display controller. Furthermore, electric lines lead from microprocessor (5) to an actuator, which in this practical example is a light-emitting diode (LED) (6). This trips an optical advance warning, which is manifested by increasing flashing frequency and which can also be supplemented by an acoustic signal induced by the control system, by an announcement or even by a display message, whenever a temperature range predetermined in the microprocessor is reached. If a further critical temperature range is exceeded, the LED switches to a continuous signal, after which the current supply to the mobile telephone is also cut off via microprocessor (5), thus turning off its function altogether.

The same system is schematically illustrated in FIG. 2. In this case, however, heat sensor (4) is designed as an electrically conductive, flexible polymer film, which is attached directly onto the surface of battery (2). In this way the basic functional principle differs from that of FIG. 1 only by a more direct temperature measurement.

Numerous further technical configurations are possible, an example being that using thermally deformable mechanical circuit elements. For example, instead of a separate, specific LED display, the microprocessor can also activate the display of the mobile telephone and output the information only via this. In all cases, the goal is to give the user an early warning of the operating status of the energy system and, if a particular temperature limit is exceeded, to bring about deactivation of the entire system. Further possibilities comprise activation of an active cooling device connected to the microprocessor, for example a micromechanical ventilation system.

1. A device, comprising:
a microprocessor functioning as a controller which controls the temperature of a battery of a mobile telephone permanently and directly during operation; and
a heat sensor mounted directly on or in the vicinity of the battery,
the microprocessor being connected to an actuator or to a display of the mobile telephone in such a way that a warning signal or warning information that can be perceived by a user's sense can be transmitted at a predetermined first temperature limit, while actuators having a cooling function can also be activated at a particular second temperature limit and operation of the mobile telephone is completely deactivated at a third temperature limit,
said device being capable of protecting said mobile telephone against overheated operating temperatures.

2. The device as claimed in claim 1, wherein the warning signal is transmitted optically, acoustically, mechanically by vibration, chemically or by a combination thereof.

3. The device as claimed in claim 1, wherein the information about the battery temperature is continuously displayed in digital or analog form on the display of the mobile telephone, or this information can be viewed on the display upon request by the user.

4. The device as claimed in claim 1, wherein control of the operating temperature of the battery and of the actuators takes place via a default program in the microprocessor.

5. The device as claimed in claim 1, which is configured as a mechanically separate functional unit containing the battery and having the form of a card, which can be reversibly inserted into the mobile telephone.

6. The device as claimed in claim 1, wherein control of the operating temperature takes place via a sensor that contactlessly measures the heat emission of said battery by infrared means.

7. The device as claimed in claim 1, wherein the heat sensor comprises a flexible, electrically conductive film, which is mounted directly on the surface of the battery.

8. The device as claimed in claim 1, comprising mechanical elements that become deformed under the effect of heat, thermocouples or thermistors or combinations thereof.

9. The device as claimed in claim 1, wherein the battery is ejected at a particular temperature by a mechanical ejection device installed in the mobile telephone.

10. The device as claimed in claim 1, wherein an active cooling device that is activated at a certain temperature limit is coupled with said device.

11. The device as claimed in claim 1, comprising capabilities for recording, storage, processing and transfer of data, data transmission being possible via electric lines, radio waves or optical beams.

12. (canceled)

13. A mobile telephone, comprising: the device according to claim 1.

14. A mobile battery-powered electrical device whose batteries represent a hazard potential technically comparable to that of mobile telephones during handling, comprising:
the device according to claim 1.

15. A method for protection against overheated operating temperatures of a mobile telephone, comprising:
permanently and directly controlling the temperature status of a battery during operation via a device, which has the form of a multi-component system comprising
a microprocessor functioning as a controller which controls the temperature of the battery of a mobile telephone permanently and directly during operation; and
a heat sensor mounted directly on or in the vicinity of the battery,
the microprocessor being connected to an actuator or to a display of the mobile telephone in such a way that a warning signal or warning information that can be perceived by a user's sense can be transmitted at a predetermined first temperature limit, while actuators having a cooling function can also be activated at a particular second temperature limit and operation of the mobile telephone is completely deactivated at a third temperature limit.

16. The method as claimed in claim 15, wherein the warning signal is transmitted optically, acoustically, mechanically by vibration, chemically or by a combination thereof.

17. The method as claimed in claim 15, wherein the information about the battery temperature is continuously displayed in digital or analog form on the display of the mobile telephone, or this information can be viewed on the display upon request by the user.

18. The method as claimed in claim 15, wherein control of the operating temperature of the battery and of the actuators takes place via a default program in the microprocessor.

19. The method as claimed in claim 15, wherein said device is configured as a mechanically separate functional unit containing the battery and having the form of a card, which can be reversibly inserted into the mobile telephone.

20. The method as claimed in claim 15, wherein control of the operating temperature takes place via a sensor that contactlessly measures the heat emission of said battery by infrared means.

21. The method as claimed in claim 15, wherein the heat sensor comprises a flexible, electrically conductive film, which is mounted directly on the surface of the battery.

22. The method as claimed in claim 15, wherein said device comprises mechanical elements that become deformed under the effect of heat, thermocouples or thermistors or combinations thereof.

23. The method as claimed in claim 15, wherein the battery is ejected at a particular temperature by a mechanical ejection device installed in the mobile telephone.

24. The method as claimed in claim 15, wherein an active cooling device that is activated at a certain temperature limit is coupled with said device.

25. The method as claimed in claim 15, wherein said device comprises capabilities for recording, storage, processing and transfer of data, data transmission being possible via electric lines, radio waves or optical beams.
